(19) United States
(12) Patent Application Publication
(10) Pub. No.: US 2016/0333633 A1
(43) Pub. Date: Nov. 17, 2016

(54) PANEL AND PANEL ASSEMBLY

(71) Applicant: INSITE MANUFACTURING PTY LTD, Victoria (AU)

(72) Inventor: Daniel Gerard Carrick, Bayswater (AU)

(21) Appl. No.: 15/110,502

(22) PCT Filed: Jan. 9, 2015
(86) PCT No.: PCT/AU2015/050004

§ 371 Date: Jul. 8, 2016

(30) Foreign Application Priority Data
Jan. 10, 2014 (AU) 2014900081
Aug. 1, 2014 (AU) 2014902983

(51) Int. Cl. E06B 9/00; E06B 3/58; E06B 3/66; E06B 5/11; E06B 9/02; E06B 3/26

(52) U.S. Cl. CPC E06B 9/00; E06B 9/02; E06B 3/26; E06B 3/6621; E06B 5/11; E06B 3/5821; E06B 2009/002; E06B 2009/015

(57) ABSTRACT

A panel has a first sheet formed of a first material, and a second material applied to at least a portion of one face of the first sheet. At least two opposed edge portions of the panel each form an edge retaining rail for retaining the respective edge portion within a channel member of a frame, and each edge retaining rail having a greater thickness than the portion of the panel immediately adjacent the respective edge retaining rail.

### FIELD OF THE INVENTION

The present invention relates to a panel and a panel assembly of a type used in providing a physical barrier to separate two adjacent.

### BACKGROUND OF THE INVENTION

It is known to use panels and panel assemblies as a physical barrier to separate two adjacent spaces in order to manage the risk of personal injury or property damage in one of those spaces, and/or to provide protection from adverse environmental conditions in one of those spaces. For example, perimeter safety guards are constructed in manufacturing facilities around machinery to isolate equipment and/or products that presents a risk of personal injury during manufacturing operations from the surrounding space. Perimeter safety guards often include a panel assembly including a panel that is supported within a frame. In certain instances, the panel is transparent to enable operators to observe the operation of the equipment without needing to enter the isolated space.

Similarly, security doors with transparent panels are used on shop fronts to allow passing pedestrians to peruse goods available for purchase. However, there is a need to secure such security doors from impact on the panels in an attempt to gain forced entry into the shop.

Panels, particularly panels spanning large distances, can be difficult to retain due to flexing of the panel. As the panel flexes, the edges are drawn inwards and can dislodge from a frame used to retain the panel. Previous panels have been made of a thick material to reduce flexing, though using thick material increases the weight of the panel and the cost.

Polycarbonate panels in particular have suffered from these issues. Although polycarbonate is a very strong material, for example it can be 250 times stronger than glass, it is very flexible and difficult to retain as once the panel flexes it can become dislodged from a frame used to retain it. Accordingly, previous panels have been formed of thick material to reduce flexing increasing the weight of the panel, and the cost. As polycarbonate panels are much lighter than panels formed of glass or aluminum, there is great potential for their use if issues surrounding retention can be addressed. it is also desirable to address other inherent issues that arise with the use of polycarbonate as a panel material, such as scratch resistance and heat expansion and contraction.

Previous attempts to address issues with panel flexing have been unsuccessful and generally inconvenient. One previous proposal is to increase the size of the frame to accommodate movement of the panel as edges are drawn inwards due to flexing. Such a solution increases costs due to increased material usage and can be unappealing aesthetically.

Another alternative is to drill an oversized hole in the panel and insert a bolt to counter flexing. Such a solution compromises structural performance of the panel as it creates a concentrated stress point which can cause cracking and failure of the panel while flexing.

Examples of the invention seek to solve, or at least ameliorate, one or more disadvantages of previous panels and panel assemblies, and/or at least provide a useful alternative.

### SUMMARY OF THE INVENTION

According to one aspect of the present invention, there is provided a panel having:
a first sheet formed of a first material;
a second material applied to at least a portion of one face of the first sheet; and
at least two opposed edge portions that each form an edge retaining rail for retaining the respective edge portion within a channel member of a frame, each edge retaining rail having a greater thickness than the portion of the panel immediately adjacent the respective edge retaining rail.

In some embodiments, each of the edge retaining rails includes a bend generally parallel to the respective adjacent peripheral edge of the first sheet, such that a respective peripheral edge portion is bent to extend back over a central portion of the panel between the side edges so as to form the respective edge retaining rail. In each edge retaining rail, the bend can be located intermediate the central portion and the adjacent peripheral edge of the first sheet, and wherein each edge portion is formed by a method involving roll forming. The peripheral edge portions can extend back over the central portion a distance in the range of 2 to 5 times the thickness of the panel.

In some alternative embodiments, each of the edge retaining rails is formed as a lamination of one or more strips onto the first sheet. Desirably, each edge retaining rail includes at least two strips, with at least one strip on each face of the first sheet. The strips and the first sheet may be formed of the first material.

The second material is applied to at least a portion of each face of the first sheet. In some embodiments, the second material, is a coating applied to the first sheet. In some alternative embodiments, the second material is at least one glass sheet that is laminated to the first sheet. In some further alternative embodiments, the panel comprises at least two glass sheets that are laminated to central portions on opposing faces of the first sheet.

The first material is preferably a polymeric material. In some examples, the first material is polycarbonate, ionoplast or polyvinyl butyral.

According to one alternative aspect of the present invention, there is provided a panel having opposed side portions bent to extend back over a central portion of the panel between the side edges so as to form side retaining rails for retaining the panel within a channeled frame of a closure, the panel having a coating applied to at least one side thereof.

In some embodiments, the coating is formed of a material having greater abrasion resistance than the panel. Preferably, the coating is of the type which is applied by dip, spray or flow coating methods.

The panel can further include a secondary sheet, and one or more spacers that extend around peripheral edges of the secondary sheet, such that a gap is provided between the secondary sheet, and the first sheet or the second material. In some embodiments, the spacer(s) extend around all peripheral edges of the secondary sheet, such that the gap is a hermetically sealed cavity.

According to another alternative aspect of the present invention, there is provided a panel having opposed side portions bent to extend back over a central portion of the panel between the side edges so as to form side retaining rails for retaining the panel within a channeled frame of a closure, the panel being in the form of a laminate comprising at least one glass sheet.

According to a preferred embodiment, the at least one glass sheet is disposed on a side of the panel which is outermost in use.

The panel can further include an air gap between the panel and the at least one glass sheet. The panel can have a coating applied to at least one side thereof. Preferably, the coating is formed of a material having greater abrasion resistance than the panel. More preferably, the coating is of the type which is applied by dip. spray or flow coating methods.

According to preferred embodiments, the opposed side edges are bent by a method of roll forming and each side retaining rail is formed by a single bend located intermediate the central portion and a tip of one of said side edges.

In some embodiments, the side edges extend back over the central portion a distance in the range of 2 to 5 times the thickness of the panel.

The panel can be formed of polycarbonate.

According to another aspect of the present invention, there is provided a panel as described above, a frame having channel members that are each adapted to receive one of the edge retaining rails in an interlocking engagement, and at least one resiliently deformable spacer that is positioned within a respective one of the channel members and at least partly between a portion of one of the edge retaining rails and the flame.

According to another aspect of the present invention, there is provided a panel assembly including a panel of the above described type and a channeled frame, the retaining rails being received by a channel formed in the frame in interlocking engagement, wherein the assembly further includes at least one resiliently deformable spacer disposed between the retaining rails and the channel.

According to another aspect of the present invention, there is provided a panel assembly including: a panel having opposed side portions bent to extend back over a central portion of the panel between the side edges so as to form side retaining rails for retaining the panel within a channeled frame of a closure; and a channeled frame, the retaining rails being received by a channel formed in the frame in interlocking engagement, wherein the assembly further includes at least one resiliently deformable spacer disposed between the retaining rails and the channel.

According to preferred embodiments, the at least one spacer is configured to deform in response to flexing of the panel to maintain engagement between the retaining rails and the channel.

Preferably, the panel is tensioned during assembly and the at least one spacer is configured to resist changes in tension in the panel. Preferably, the or each spacer is received against an edge of the retaining rails.

According to preferred embodiments, the or each spacer is elongate and extends substantially along the edge of the retaining rails. Preferably, the spacer is formed of rubber.

According to a preferred embodiment, the frame is formed of a PVC material. Preferably, the frame is extruded.

The panel assembly can further include a finishing cap to cover an interface between the panel and the frame.

In some embodiments, the panel assembly further includes a secondary sheet that is supported by the frame, and wherein the frame is configured such that an air gap is provided between the panel and the secondary sheet.

According to preferred embodiment, the assembly is configured for use as, or as a component part of, a machine safety guard, a door, a garage door, a door or window for a building, or a wind and weather shelter, Preferably, the window is suitable for use in cyclonic conditions. In another form, the assembly is suitable for use as a garage door. In one form, the garage door may be sized 11 m by 4 m.

According to another aspect of the present invention, there is provided a panel having.
at least two opposed side portions that each form a side retaining rail for retaining the respective side portion within a channeled frame of a closure, each side retaining rail having a greater thickness than the portion of the panel immediately adjacent the respective side retaining rail; and
a coating applied to at least one side thereof.

According to another aspect of the present invention, there is provided a panel having at least two opposed side portions that each form a side retaining rail for retaining the respective side portion within a channeled frame of a closure, each side retaining rail having a greater thickness than the portion of the panel immediately adjacent the respective side retaining rail, the panel being in the form of a laminate comprising a first sheet of polymeric material, and at least one glass sheet.

According to another aspect of the present invention, there is provided a panel comprising:
a first sheet made of polymeric material, and having at least two opposed side portions that each form a side retaining rail for retaining the respective side portion within a channeled frame of a closure,
one or more glass sheets that are laminated to a central portion of the first sheet, wherein peripheral edges of the glass sheets are spaced from the side rails to form intermediate portions of the first sheet that are each between one of the side retaining rails and the peripheral edges of the glass sheets the intermediate portions being thinner than the side retaining rails.

According to another aspect of the present invention, there is provided a panel assembly including:
a panel as previously described;
a frame having channels that are each adapted to receive one of the side retaining rails in interlocking engagement; and
a plurality of resiliently deformable spacers, that are each positioned within a respective one of the channels, and at least partly between a portion of the retaining rails and the frame.

### BRIEF DESCRIPTION OF THE DRAWINGS

Preferred embodiments of the invention will be further described, by way of non-limiting example only with reference to the accompanying drawings, in which:

FIG. 1 is a perspective view of a perspective view of a panel of one embodiment of the invention;

FIG. 2 is an enlarged side view of the panel of FIG. 1;

FIG. 3 is a sectional side view of a panel installed in a frame to form a panel assembly in accordance with another embodiment of the invention;

FIG. 4 is a sectional side view of a panel installed in another frame to form a panel assembly;

FIG. 5 is a sectional side view of a panel assembly having a laminated panel and secondary glazing sheet;

FIG. 6 is a sectional side view of another panel assembly having a laminated panel and secondary glazing sheet;

FIG. 7 is a sectional side view of another panel assembly having a differently configured clamping member;

FIGS. 8 and 9 are sectional side views of other panel assemblies having similar clamping members though panels of different thicknesses;

FIG. 10 is a sectional side view of another panel assembly having a differently configured clamping member;

FIG. 11 is a perspective view of a perspective view of a panel of another embodiment of the invention;

FIG. 12 is a partial side view of the panel of FIG. 11;

FIG. 13 is a sectional side view of the panel of FIG. 11 installed in a frame to form a panel assembly according to another embodiment of the invention;

FIG. 14 is a sectional side view of a panel assembly according to another embodiment of the invention; and

FIG. 15 is a sectional side view of another panel assembly having a laminated panel including a secondary glazing sheet.

### DETAILED DESCRIPTION

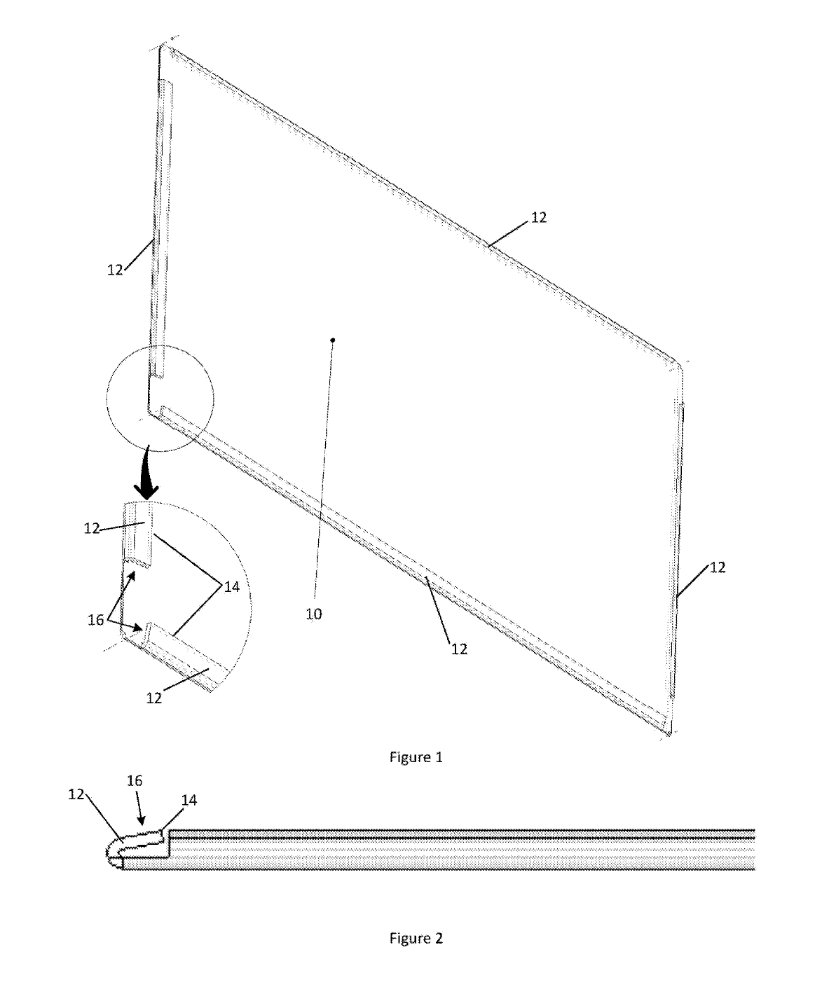

With reference to FIG. 1, there is shown a panel 10 according to an embodiment of the invention. The panel 10 has a sheet formed of a first material, and a. second material applied to at least a portion of one face of the first sheet. In this particular embodiment, the second material is a coating that is applied to a face (in other words a “side”) of the first sheet. The panel 10 also has four opposed edge portions that each form an edge retaining rail that is suitable for retaining the respective edge portion within a channeled frame of a closure, as described in further detail below. Each edge retaining rail has a greater thickness than the portion of the panel immediately adjacent the respective edge retaining rail. In this particular embodiment, the four edge retaining rails form two pairs of opposed side portions 12, each side portion 12 being bent to extend back over a central portion of the panel between the side edges 14. The edge retaining rails (hereinafter referred to as “side retaining rails 16”) are for retaining the panel 10 within a channel member of a frame. In some other embodiments, the panel 10 may have a coating applied to both faces/sides thereof.

In this embodiment, the panel is formed of as polycarbonate material, though it will be appreciated that other similar materials may be used.

By providing an upturned edge 14, the panel 10 can be retained in a frame by taking advantage of the panels tensile strength, Furthermore, the edge 14 acts as a hook to engage the frame and resist removal.

The coating is preferably formed of a material having greater abrasion resistance than the panel. Advantageously, different uses for materials such as polycarbonate which are vulnerable to scratching are possible. In one form, the coating is of the type which is applied by dip, spray or flow coating methods, though it will he appreciated that other types of coating may he used. In one embodiment, the coating is a conventional hard coating, such as a 2 pack polyurethane clear coat.

In another embodiment, the panel has, similar to the previous embodiment, opposed side portions bent to extend back over a central portion of the panel between the side edges so as to form side retaining rails for retaining the panel within a channeled frame of a closure, though in this embodiment the panel is in the form of a laminate comprising at least one glass sheet that covers at least a portion of one face of the first sheet.

The side on which the glass sheet is disposed can vary according to the application and the required properties of the panel. In one form the at least one glass sheet is disposed on a side of the panel which is outermost in use. When a laminate formed of polycarbonate and glass is provided, such a panel could advantageously be used in applications where high strength is required though the entry of glass into an inside area must be prevented in the event of damage to the window. One such application is for windows for use in areas exposed to high wind loading such as tropical areas prone to cyclones.

Providing a laminated panel allows the material properties of polycarbonate and glass to be combined. For example, the stiffness of glass can reduce flexing of the panel and the toughness of polycarbonate can improve the shatter resistance of glass. Also if breakage occurs then glass fragments can he prevented from entering the building. As will be apparent to the person skilled in the art, the laminated panel has differing mechanical properties when compared with the polycarbonate sheet. To this end, the lamination of glass to the polycarbonate provides the panel with increased stiffness, when compared with a polycarbonate sheet alone.

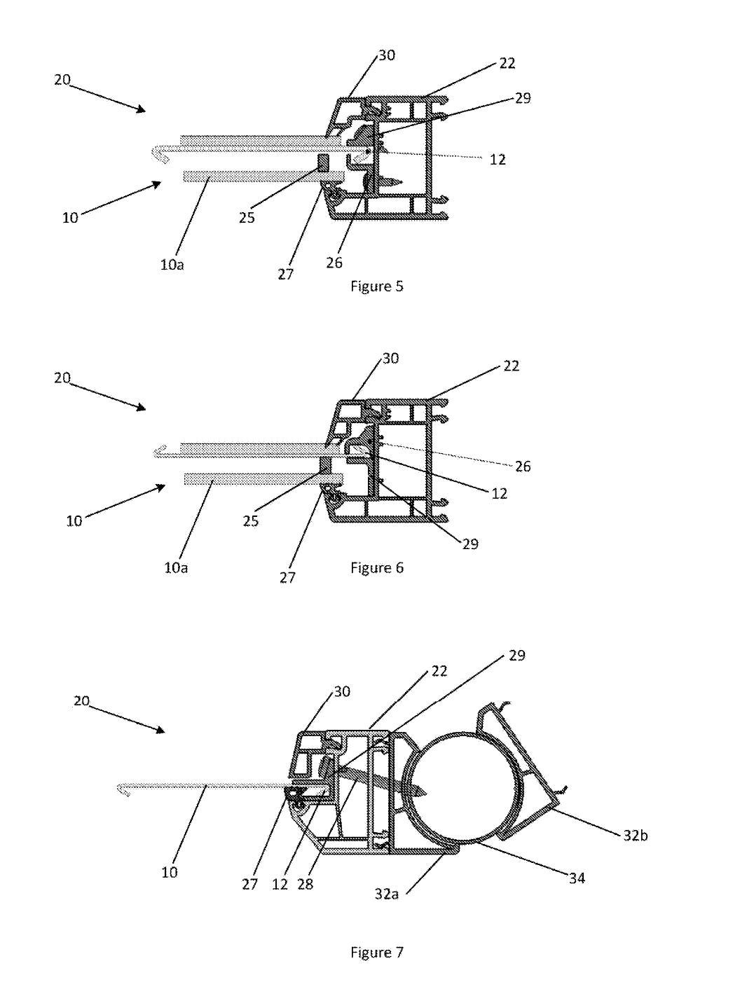

The panel may be formed with an air gap between the panel and the at least one glass sheet. In such an embodiment, a spacer 25 such at that shown in FIG. 5 may be disposed between the panel and the glass sheet. Such a panel can provide excellent insulation properties.

It will be appreciated that numerous combinations of laminate are possible. For example the glass sheet may be bonded directly to the panel on either an inside or an outside surface. Either panel may be modified so as to include an air gap between the panel and the glass sheet.

In other forms, the panel may include a laminate of like materials, with or without an air gap in between. In a further modification, one layer of this laminate may have a glass sheet bonded thereto. For example, the laminate can include a panel formed of polycarbonate, an air gap and a second polycarbonate sheet with a glass sheet bonded thereto. The second polycarbonate sheet/glass sheet layer may be disposed on either an inner or an outer surface of the panel.

Examples of panels of laminated construction are illustrated in FIGS. 5 and 6.

Similar to the first described embodiment, a panel in the form of a laminate may have a coating applied to at least one side thereof. The coating is preferably formed of a material having greater abrasion resistance than the panel. Advantageously, different uses for materials such as polycarbonate which are vulnerable to scratching are possible. In one form the coating is of the type which is applied by dip spray or flow coating methods, though it will be appreciated that other types of coating may be used In one embodiment, the coating is a conventional hard coating, such as a 2 pack polyurethane clear coat. As will be apparent to the person skilled in the art, the panel including the coating has differing mechanical properties when compared with the polycarbonate sheet. To this end, the coating provides the panel with a greater abrasion resistance, when compared with a polycarbonate sheet alone.

The coating can be applied to different sides of the panel, and is preferably applied to a side or sides of the panel which is/are exposed. For example, a panel having an outer glass sheet may have the coating applied to an inner surface to prevent scratching of the panel in use.

In each of the previously described embodiments, the opposed side edges 14 are bent by a method of roll forming and each side retaining rail 16 is formed by a single bend located intermediate the central portion and a tip of one of said side edges 14, as can be seen in FIG. 2.

The degree of flexure of the panel can vary according to the size of the panel, the material used and the thickness of the panel. Accordingly, the configuration of the side rails can be varied according to the thickness of the panel. The inventor has found that side edges which extend back over the central portion a distance in the range of 2 to 5 times the thickness of the panel provides particularly good retention within a frame, especially when the panel is formed of polycarbonate.

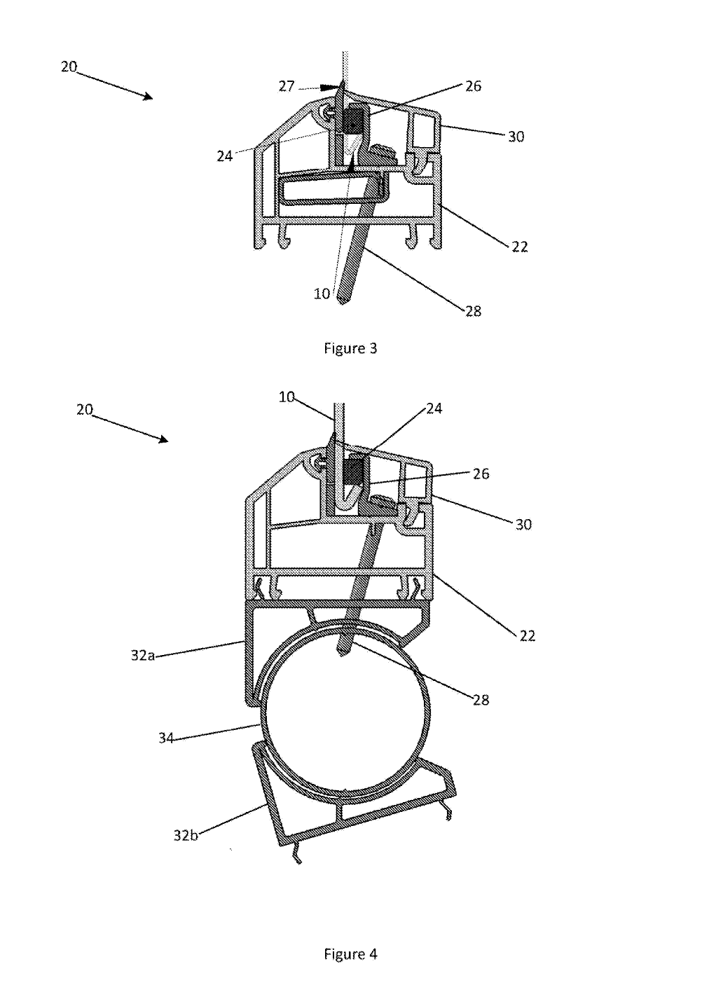

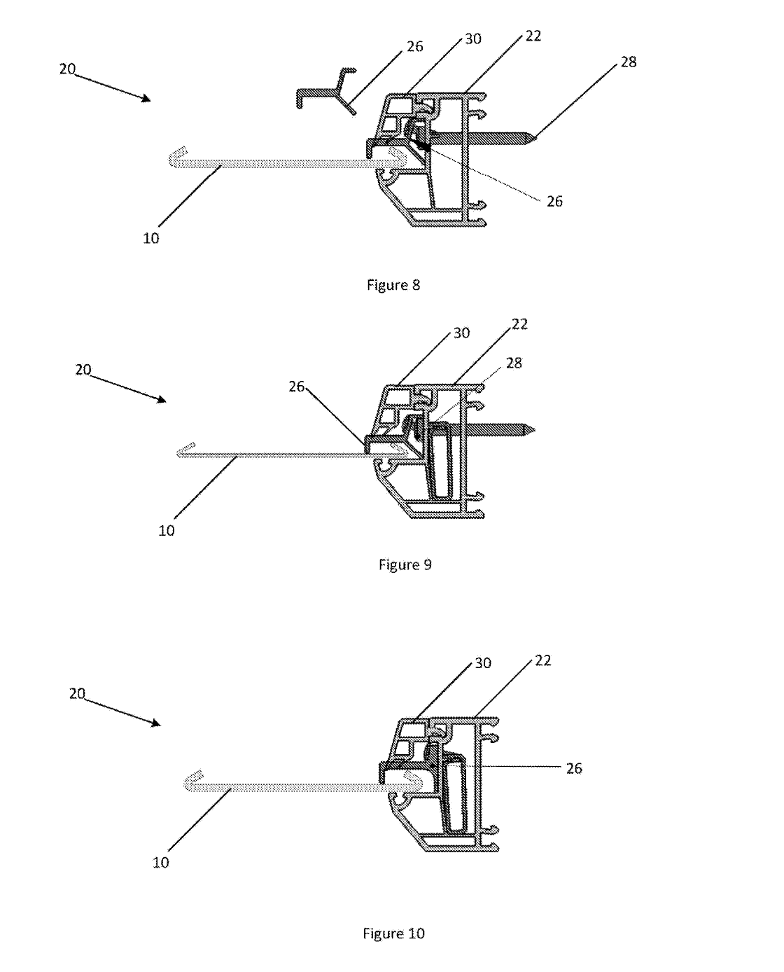

FIGS. 3 to 10 illustrate various panel assemblies 20. The panel assembly 20 includes a panel 10 that is substantially similar to the panel shown in FIG. 1. Accordingly, the panel 10 has opposed side portions 12 that are bent to extend back over a central, portion of the panel 10 between the side edges 14 so as to form side retaining rails 16 for retaining the panel 10 within a frame that includes channel members 22, one of which being shown in FIGS. 3 to 10. The frame can be configured to provide a closure (such as a door or window) to an opening. The retaining rails 16 are received, by a channel formed in the frame 22 in interlocking engagement. As illustrated in FIGS. 3 and 4 the panel assembly 20 further includes at least one resiliently deformable spacer 24 that is positioned or disposed within, the channel member 22, and at least partly between the retaining rails 16 and the. frame. In FIGS. 5 to 10, the spacer 24 has been omitted for clarity.

The panel assembly 20 may include a panel 10 of the above described type, though it does not necessarily require that the panel have, a coating applied thereto or that the panel be in the form of a laminate comprising a glass sheet.

The spacer 24 is configured to deform in response to flexing of the panel to maintain engagement between the retaining rails 16 and the channel. The panel 10 is tensioned during assembly and the spacer 24 is configured to resist changes in tension in the panel 10. Advantageously, expansion or contraction due to changes in heat can be accommodated without reducing the structural integrity or appearance of the panel.

The panel assembly 20 is configured so that tension is applied to the panel 10 during assembly. To apply this tension, the spacer 24 is received against an edge of the retaining rails 16 and as the spacer is compressed as the panel 10 is installed, thereby tensioning the panel, By applying tension to the panel natural waviness of the panel can be eliminated or reduced, particularly if polycarbonate is the material used for the panel. This improves the aesthetics of the panel.

The spacer 24 is illustrated, in cross section and although not illustrated, in one form the spacer is elongate and extends substantially along the edge of the retaining rails. In other forms the spacer 24 is formed in separate pieces and in one example, each retaining rail may be provided with an individual spacer 24. In another example, multiple spacers 24 may be provided for each retaining rail.

The spacer is formed of a resiliently deformable material such as rubber. In a preferred form, the spacer is configured so as to be resiliently compressible and is compressed during assembly of the panel assembly and the resilience of the spacers acts so as to maintain tension in the panel once assembled. Furthermore, the spacer is compressible to absorb and disperse forces in the event that the panel is subjected to impact forces. wind loads, and like applied forces.

During assembly, channeled frame 22 is provided and the panel 10 is positioned in the frame 22. The spacer 24 is positioned on the panel 10 and than an elongate clamping member 26 is pushed against the spacer 24, thereby acting upon the edge 14 of the retaining rail 16. A support 29 may be provided, against which a side of the panel can be received. The clamping member 26 is fixed to the frame 22 using a threaded fastener 28 and as the fastener is tightened the clamping member 26 urges the spacer 24 and the retaining rail 16 toward the frame 22 to tension the panel. By preloading the spacer 24 during assembly, a desired amount of tension can be applied to the panel.

The clamping member 26 may take different forms, such as that shown in FIG. 7 for example, in which the clamping member and support are integrally formed. In such an embodiment, a seal 27 may be used to seal a gap between the panel 10 and the flame 22.

Once the clamping member 26 has been installed, a finishing cap 30 may be installed to cover an interface between the panel 10, the clamping member 26 and the frame 22.

With reference to FIGS. 5 and 6, it can be seen that the panel may be orientated so that the retaining rails 16 are disposed on either side of the panel assembly, as required. in respect of assembly., in some applications it may be more convenient to have the rails 16 facing a side of the window which is innermost in use For example, it will be desirable for security windows to have the finishing cap 30, and thus access to fastener 28 on the inside of the assembly and not externally accessible.

FIG. 4 illustrates a panel assembly configured for use in an application where adjustment. of an angle between the panel and a frame is required. In this embodiment, two frame members 32a, 32b are provided and configured to receive a generally cylindrical intermediate member 34. The frame members 32a, 32b can slide around the cylindrical member 34 so as to provide adjustment until the desired angle is found. Once positioned, a fastener, such as fastener 28 can he passed through the frame members and into the cylindrical member to lock these parts together.

FIGS. 5 and 6 also illustrate various configurations of panels 10 that may be used in the panel assembly 20. in this regard, there is illustrated a panel in the form of a laminate, as previously described. A further sheet 10a may be provided for double glazing to improve insulation properties of the panel. The further sheet 10a may be formed of a number of different materials, such as glass or polycarbonate for example. Where a further sheet 10a is used, the finishing cap 30 is modified to accommodate the additional thickness.

The frame 22 is preferably formed of individual members which are formed using an extrusion process so that channels for receipt of the panel can be readily formed. In preferred embodiments, the frame 22 is formed of a PVC material. Advantageously, the frame can be formed quickly and easily in a low cost manner. In addition the insulation properties of a PVC frame are superior to that of a metallic frame, which has a higher heat conduction than PVC.

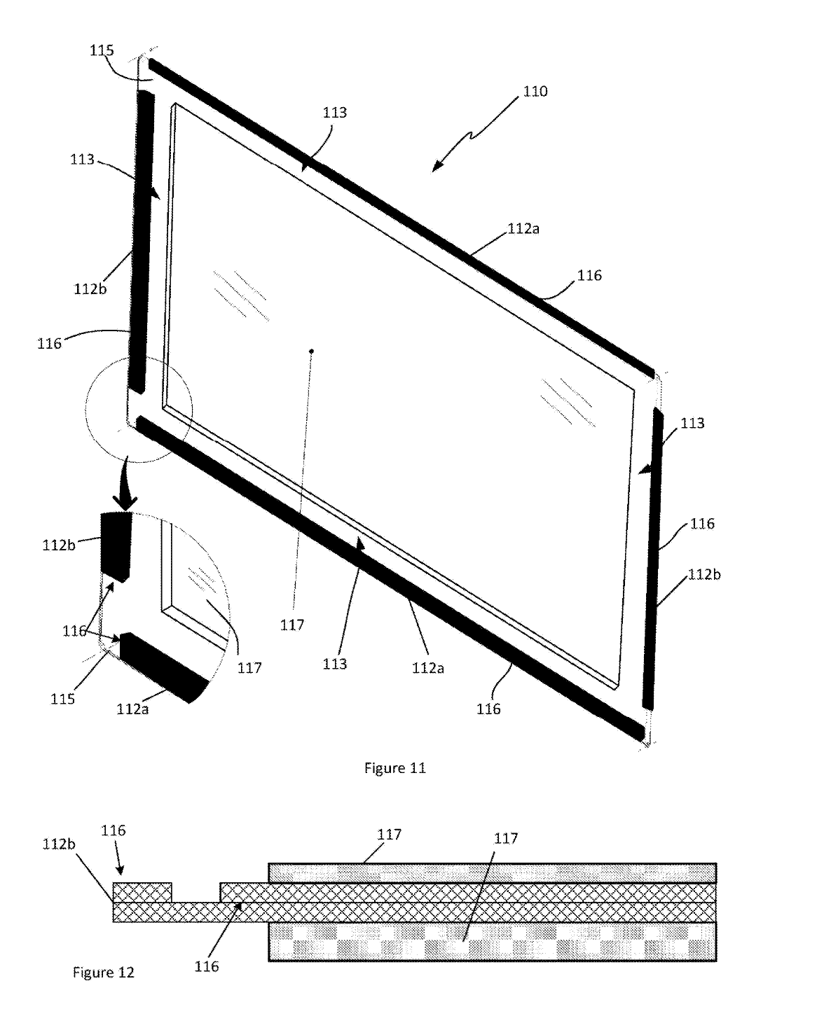

FIGS. 11 and 12 show a panel 110 according to another embodiment of the invention. The panel 110 of this embodiment has two pairs of opposed edge portions 112a, 112b (hereinafter referred to collectively as “edge portions 112”). At each of the edge portions 112 there is formed an edge retaining rail 116 that can be used in retaining the respective side portion 112 within a channeled frame of a closure. Each edge retaining rail 116 has a thickness that is greater than the intermediate portion 113 of the panel 110 immediately adjacent the respective edge retaining rail 116. In this particular embodiment, the panel 110 is a laminate that includes a first sheet 115 of polymeric material, and two glass sheets 117. In preferred embodiments, the first sheet 115 is made of ionoplast. In certain examples, the glass sheets 117 are made of an annealed glass.

As will be apparent from FIG. 11, the glass sheets 117 are laminated to a central portion of the first sheet 115, such that the peripheral edges of the glass sheet 117 are spaced inwardly from the edge retaining rails 116. The intermediate portions 113 of the first sheet 115 are formed intermediate between the edge retaining rails 116 and the peripheral edges of the glass sheet 117.

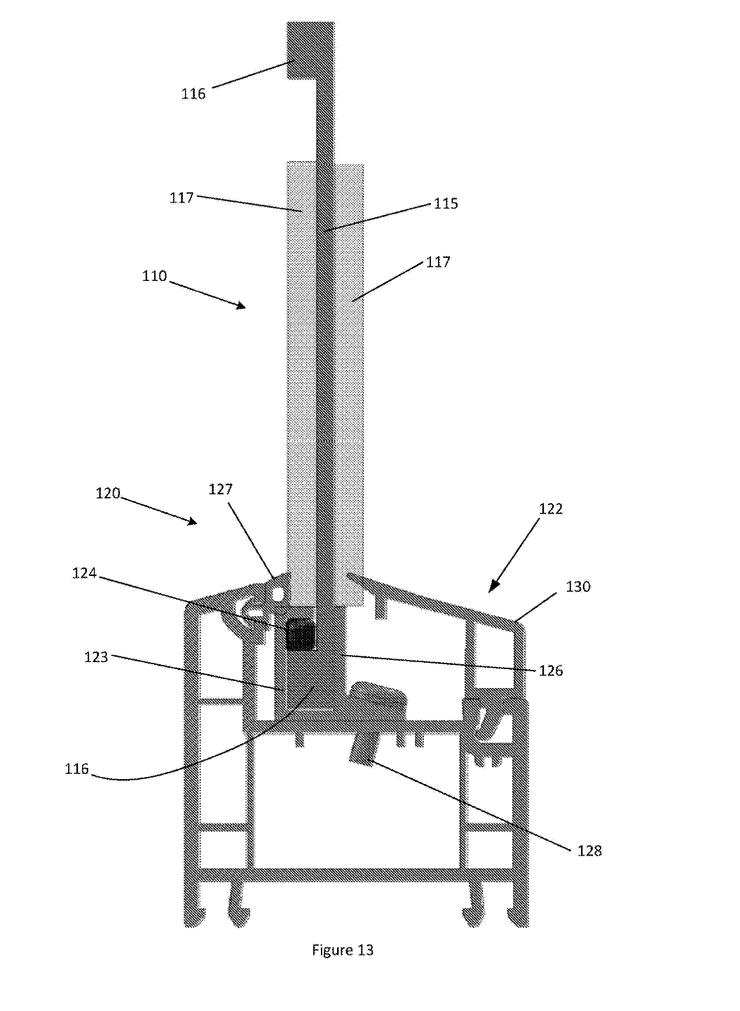

The edge retaining rails 116 provide an enlarged edge relative to the intermediate portions 113 of panel 110. Thus, the panel 110 can be retained in a frame by taking advantage of the panel's tensile strength. Furthermore, the edge retaining rails 116 are arranged to engage the frame and resist removal, as described below in connection with FIG. 13.

As shown schematically in FIG. 12, each edge retaining rail 116 of this particular embodiment is formed by lamination of a strip of material onto one of the major faces of the first sheet 115. The strip of material can conveniently be of the same material as the first sheet 115.

FIG. 13 shows a panel assembly 120 that includes a panel 110 as described above in connection with FIGS. 11 and 12, and a frame 122 that includes a channel member 123 (one of which is shown in FIG. 13). Each edge retaining rail 116 is received in the channel member 123 in interlocking engagement. The assembly 120 further includes resiliently deformable spacers 124 that are each positioned within a respective one of the channels, and at least partly between a portion of the retaining rails 116 and the frame 122.

The panel assembly 120 is otherwise substantially similar to the panel assemblies 20 shown in FIGS. 3 to 11. Accordingly, features of the panel assembly 120 that are substantially similar to those of the assembly 20 have the same reference numeral with the prefix “1”.

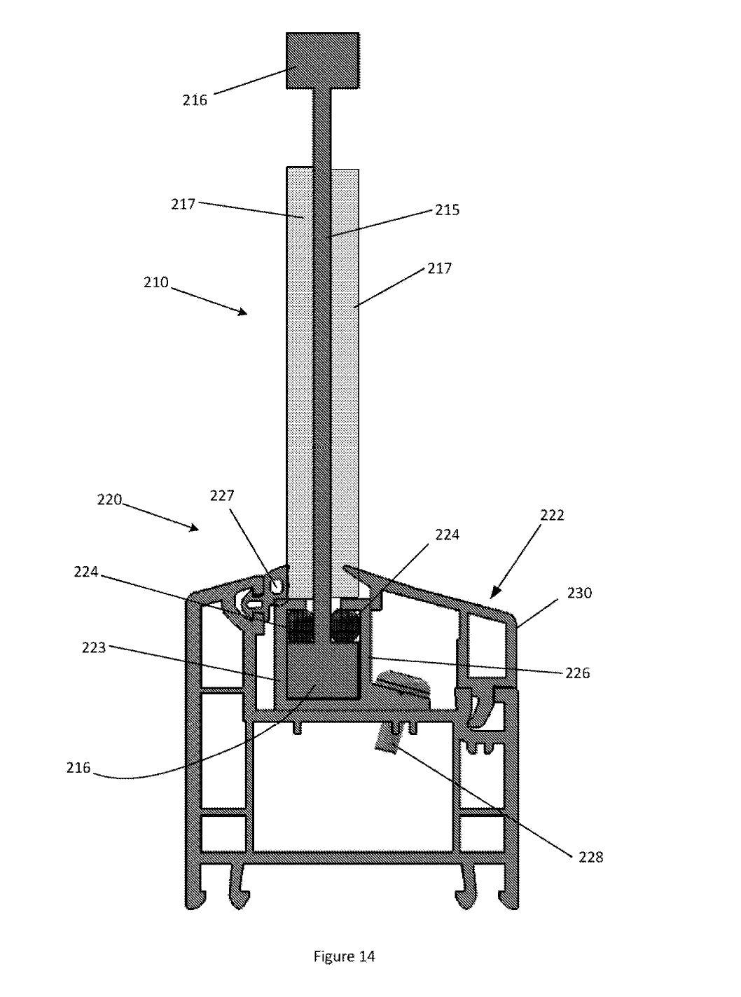

FIG. 14 shows a panel assembly 220 that includes a panel 210, and a frame 222 that includes a channel member 223 (one of which is shown in FIG. 14). The panel 210 is substantially similar to the panel 110 of FIG. 11. In FIG. 14, the features of the panel 210 that are substantially similar to those of the panel 110 have the same reference numeral with the prefix “2” replacing the prefix “1”.

Each edge retaining rail 216 of the panel 210 is received in the channel member 223 in interlocking engagement. The assembly 220 further includes resiliently deformable spacers 224 that are each positioned within a respective one of the channel members 223, and at least partly between a portion of the edge retaining rails 216 and the frame 222.

The principle difference between the panel 110 and the panel 210 lies in the construction of each edge retaining rail 216. To this end, each edge retaining rail 216 of this particular embodiment is formed by lamination, of strips of material onto the opposing major faces of the first sheet 215, at the respective side portion 212.

The channel members 223 of the frame 222 are shaped to provide interlocking engagement to the respective edge retaining rail 216 on opposing major faces first sheet 215. To support external loads applied to either side of the panel 220, the panel assembly 220 has two spacers 224 extending along each side retaining rail 216.

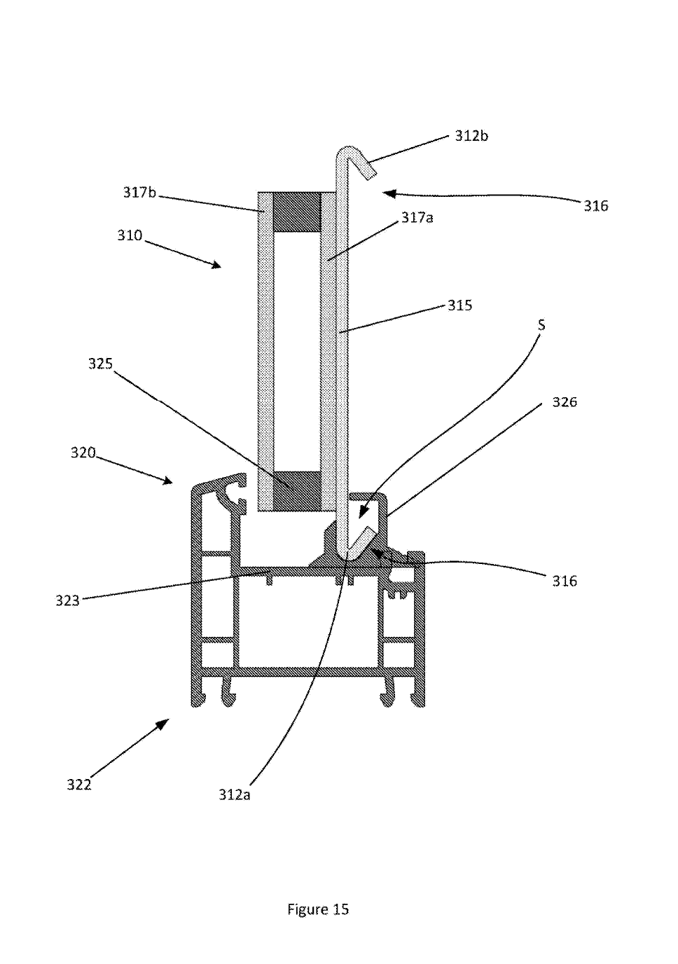

FIG. 15 shows a panel assembly 320 that includes a panel 310, and a frame 322 according to another embodiment of the invention. The panel 310 of this embodiment is of laminate construction that, includes a first sheet 315 of polymeric material, and two glass sheets 317a, 317b. In certain examples, the glass sheets 317a, 317b are made of an annealed glass. The panel 310 is formed with opposed edge portions 312a, 312b (hereinafter referred to collectively as “edge portions 312”). At each of the edge portions 312 there is formed an edge retaining rail 316 that can be used in retaining the respective side portion 312 within a channel member 323 of the frame 322. To this end, in this embodiment, the frame 322 includes an elongate clamping member 326 that co-operates with the channel member 323 to form the channel within which the panel 310 is retained.

As will be appreciated, the panel assembly 320 is to also include one or more resiliently deformable spacers that are each positioned within a respective one of the channel members 323, and at least partly between a portion of the edge retaining rails 316 and the frame 322. In FIG. 15, the resiliently deformable spacers have been omitted for clarity, although the location of the resiliently deformable spacer between the edge retaining rail 316 and the channel member 323 is indicated by arrow S.

Each edge retaining rail 316 has a thickness that is greater than the intermediate portion 313 of the panel 310 immediately adjacent the respective edge retaining rail 316. In this particular embodiment, the edge retaining rail is in the form of a side portion 312 with a bend generally parallel to the respective adjacent peripheral edge of the first sheet, such that a respective peripheral edge portion is bent to extend back over a central portion of the panel between the side edges.

As shown in FIG. 15, one of the glass sheets 317a is laminated to the first sheet 315. The panel assembly 310 includes a spacer 325 that is bonded to both the glass sheets 317a, 317b so as to space the glass sheets 317a, 317b in a parallel arrangement and provide a gap between the glass sheets 317a, 317b. The gap may be filled with air, other gas, or mixtures thereof in order to maximize the insulating properties of the panel 310. Alternatively or additionally, the gap may be partially or fully evacuated. As will be appreciated, a plurality of spacers 325 tone of which is shown in FIG. 15) may extend around all peripheral edges of the glass sheets, such that the gap between the glass sheets is a hermetically sealed cavity. Desiccants and/or other products may be disposed within the cavity, as is known to be used in the glazing industry.

As will be evident from FIGS. 3 to 10, and FIGS. 13 to 15, each edge retaining rail provides a portion of the respective panel that projects laterally in at least one direction with respect to the adjacent face of the panel immediately beside the respective edge retaining rail. Thus, the edge retaining rail is configured to interlock with a complementary portion of the frame. This interlocking arrangement operates to restrain the edge retaining rail within the respective channel of the frame.

The described panels and panel assemblies provide a strong and light weight solutions with many different applications, such as use as a machine guard, walls or partitions, weather shelters (for example a public transport shelter, such as a bus shelter), or windows for a building, particularly security or burglar resistant windows and windows which are suitable for use in cyclonic conditions. In addition, the described embodiments can have applications in doors such as garage doors or, in particular, emergency response garage doors.

Furthermore, in certain applications large spans of glass cannot be used, for example in a garage door or domestic window. One issue with glass panels of this size is the weight of the panel and vulnerability to breakage. Where glass isn't considered safe over a certain size due to glasses inherent properties, it is desirable to use panels formed of other materials. The described panels formed of more flexible materials such as polycarbonate that are locked into a frame can overcome some of these safety issues. The inventor has found that using the described principles, a polycarbonate panel can be used as a 2.5 m by 1.8 m panel that replaces several 1.2 m by 0.6 m panels in a garage door for emergency vehicles. This panel increases visibility and reduces weight over previous glass panels. In other examples, the described principles can be used to manufacture a garage door of a size up to 11 m by 4 m.

The embodiments have been described by way of example only and modifications are possible within the scope of the invention disclosed. For example, although the panel has been described with reference to polycarbonate material, it will be appreciated that other similar materials may he used.

1. A panel having:
a first sheet formed of a first material;
a second material applied to at least a portion of one face of the first sheet; and
at least two opposed edge portions that each form an edge retaining rail for retaining the respective edge portion within a channel member of a frame, each edge retaining rail having a greater thickness than the portion of the panel immediately adjacent the respective edge retaining rail.

2. A panel according to claim 1, wherein each of the edge retaining rails includes a bend generally parallel to the respective adjacent peripheral edge of the first sheet, such that a respective peripheral edge portion is bent to extend back over a central portion of the panel between the side edges so as to form the respective edge retaining rail.

3. A panel as claimed in claim 2, wherein, in each edge retaining rail, the bend is located intermediate the central portion and the adjacent peripheral edge of the first sheet, and wherein each edge portion is formed by a method involving roll forming.

4. A panel as claimed in claim 2, wherein the peripheral edge portions extend back over the central portion a distance in the range of 2 to 5 times the thickness of the panel.

5. A panel according to claim 1, wherein each of the edge retaining rails is formed as a lamination of one or more strips onto the first sheet.

6. A panel as claimed in claim 5, wherein each edge retaining rail includes at least two strips, with at least one strip on each face of the first sheet.

7. A panel as claimed in claim 5, wherein the strips and the first sheet are formed of the first material.

8. A panel as claimed in claim 1, wherein the second material is applied to at least a portion of each face of the first sheet.

9. A panel as claimed in any one of claim 1, wherein the second material is a coating applied to the first sheet.

10. A panel as claimed in claim 9, wherein the second material has a greater abrasion resistance than the first material.

11. A panel as claimed in claim 9, wherein the coating is of the type which is applied by dip, spray or flow coating methods.

12. A panel as claimed in any one of claim 1, wherein the second material is at least one glass sheet that is laminated to the first sheet.

13. A panel as claimed in claim 12, wherein the at least one glass sheet is disposed on a side of the panel which is outermost in use.

14. A panel according to claim 12, comprising at least two glass sheets that are laminated to central portions on opposing faces of the first sheet.

15. A panel as claimed in any one of claim 1, wherein the first material is a polymeric material.

16. A panel as claimed in claim 15, wherein the first material is one of polycarbonate, ionoplast or polyvinyl butyral.

17. A panel assembly including:
a panel according to claim 1;
a frame having channel members that are each adapted to receive one of the edge retaining rails in an interlocking engagement; and
at least one resiliently deformable spacer that is positioned within a respective one of the channel members, and at least partly between a portion of one of the edge retaining rails and the frame.

18. An assembly as claimed in claim 17, wherein the at least one spacer is configured to deform in response to flexing of the panel to maintain engagement between the respective edge retaining rail and channel member.

19. An assembly as claimed in claim 17, wherein the panel is tensioned during assembly and the at least one spacer is configured to resist changes in tension in the panel.

20. An assembly as claimed in claim 17, wherein the or each spacer is received against an edge of the respective edge retaining rail.

21. An assembly as claimed in claim 17, wherein the or each spacer is elongate and extends substantially along the edge of the respective edge retaining rail.

22. An assembly as claimed in claim 17, wherein the spacer is formed of rubber.

23. An assembly as claimed in claim 17, further including a finishing cap to cover an interface between the panel and the frame.

24. A panel assembly as claimed in claim 17, further including a secondary sheet that is supported by the frame, wherein the frame is configured such that an air gap is provided between the panel and the secondary sheet.

25. A panel assembly as claimed in claim 17, being configured for use as one of: a machine safety guard, a window or door for a building, or a weather shelter.

26. A panel having opposed side portions bent to extend back over a central portion of the panel between side edges of the panel so as to form side retaining rails for retaining the panel within a channeled frame of a closure, the panel having a coating applied to at least one side thereof.

27. A panel as claimed in claim 26, wherein the coating is formed of a material having greater abrasion resistance than the panel.

28. A panel having opposed side portions bent to extend back over a central portion of the panel between the side edges so as to form side retaining rails for retaining the panel within a channeled frame of a closure, the panel being in the form of a laminate comprising at least one glass sheet.

29. A panel as claimed in claim 28, further including an air gap between the panel and the at least one glass sheet.

30. A panel as claimed in claim 26, wherein the opposed side edges are bent by a method of roll forming, and each side retaining rail is formed by a single bend located intermediate the central portion and a tip of one of said side edges.

31. A panel assembly including a panel as claimed in claim 26 and a channeled frame, the retaining rails being received by a channel formed in the frame in interlocking engagement, wherein the assembly further includes at least one resiliently deformable spacer disposed between the retaining rails and the channel.
